(19) United States
(12) Patent Application Publication
(10) Pub. No.: US 2005/0193538 A1
(43) Pub. Date: Sep. 8, 2005

(54) Multi-purpose tool for scale model vehicles

(76) Inventors: Joel Quinn, South Jordan, UT (US); George E. Newby, Ririe, ID (US); Chris Sullivan, Rock Springs, WY (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 11/073,297

(22) Filed: Mar. 4, 2005

Related U.S. Application Data
(60) Provisional application No. 60/550,895, filed on Mar. 5, 2004.

(51) Int. Cl. B23B 45/00

(52) U.S. Cl. 29/26 A

(57) ABSTRACT

A multi-purpose tool includes a power module for supplying power, a drive member for imparting a rotational force, a cord attachable to the power module, the cord being configured to attach to and heat a glow plug, and a connector coupled to the power module, the connector being configured to supply power from the power module to an external electrical device.

### RELATED APPLICATIONS

The present application claims the benefit of U.S. Provisional Patent Application Ser. No. 60/550,895, filed Mar. 5, 2004, which application is incorporated herein by reference in its entirety.

### TECHNICAL FIELD

The present disclosure relates generally to tools. More specifically, the present disclosure relates to portable electric tools configured to perform multiple functions associated with scale model vehicles.

### BACKGROUND

Remote controlled scale model vehicles are extremely popular worldwide and are available in a number of different forms, such as cars, trucks, aircraft, and boats. Thee remote controlled scale model vehicles are commonly used by enthusiasts for recreation and racing. Many remote controlled vehicles are scale models of larger vehicles, such as a 1/10th scale semi tractor trailer, for example. Many remote controlled scale model vehicles are powered by nitro-methane engines that may have various different starting mechanisms. For example, some remote controlled model vehicles have electric starter motors that require attachment of an electric source for starting the engine. Alternatively, many remote controlled scale model vehicles include manual pull starting devices. Still other vehicles include mechanical rotary drive starting devices that may require attachment of a rotary device such as a power screw driver for starting the engine. While the starting devices employed by the various nitro-methane vehicles may vary, all nitro-methane vehicles require heating of the glow plug for starting.

Accordingly, model vehicle enthusiasts are often faced with purchasing a number of different tools to start the different types of remote controlled model vehicles. Each of the various tools may be expensive which may add to the cost of operating the remote controlled model vehicles, particularly when a variety of different vehicles are used.

Further, additional tools, such as screw drivers, drills, and rotary wrenches may be useful in assembling, operating and maintaining the remote controlled model vehicles. If each of the tools is acquired separately, the cost of the tools may be significant. Moreover, the space required to store the various different tools is increased and it becomes increasingly difficult to manage the tools as the number of tools increases.

### SUMMARY

In one of many possible embodiments, a multi-purpose tool includes a power module for supplying power, a drive member for imparting a rotational force, a cord attachable to the power module, the cord being configured to attach to and heat a glow plug, and a connector coupled to the power module, the connector being configured to supply power from the power module to an external electrical device.

According to another embodiment, a multi-purpose tool includes a means for assembling a scale-model vehicle, a means for operating a scale model vehicle, and a means for maintaining a scale model vehicle.

According to yet another embodiment, a power module includes a housing, a plurality of power storage devices disposed within the housing, a connector electrically coupled to the plurality of power storage devices, wherein the connector is configured to electrically couple the power module to both a glow plug heating cord and an electrical starter motor, and an electrical coupler configured to electrically couple the plurality of power storage devices to a drill.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is an exploded side view of a tool including a cord, according to one exemplary embodiment.

FIG. 1A is an exploded side view of a multi-purpose tool, according to one exemplary embodiment.

FIG. 1B is an end view of a glow plug connector, according to one exemplary embodiment.

FIG. 1C is a break-away side view of a cord and glow plug connector attached to a glow plug, according to one exemplary embodiment.

FIG. 2 is an exploded side view of a model vehicle and a starting module of a multi-purpose tool, according to one exemplary embodiment.

FIG. 2A is an exploded side view of a model vehicle and a multi-purpose tool, according to one exemplary embodiment.

FIG. 2B is a schematic wiring diagram of a model vehicle and a multi-purpose tool, according to one exemplary embodiment.

FIG. 3 is an exploded side view of a model vehicle with a manual pull start, a starting module, a cord, and a glow plug connector, according to one exemplary embodiment.

FIG. 3A is an exploded side view of a model vehicle with a manual pull start and a multi-purpose tool, according to one exemplary embodiment.

FIG. 4 is a top view of a model vehicle having a mechanical rotary drive and a multi-purpose tool, according to one exemplary embodiment.

FIG. 5 is a top view of a model vehicle and three separate functions that may be performed by the present multi-purpose tool, according to one exemplary embodiment.

FIG. 6 is a schematic wiring diagram of a multi-purpose tool, according to one exemplary embodiment.

FIG. 6A is a schematic wiring diagram, according to one exemplary embodiment.

Throughout the drawings, identical reference numbers designate similar, but not necessarily identical, elements.

### DETAILED DESCRIPTION

The present specification discloses a multi-purpose tool for use with scale model vehicles. More specifically, a tool is disclosed that is simultaneously configured to connect to an external electrical device, supply power, impart a rotational force, and heat a glow plug. By incorporating the above-mentioned capabilities in a single tool, storage space is minimized, tool costs are reduced, and convenience is enhanced.

In the following description, for purposes of explanation, numerous specific details are set forth in order to provide a thorough understanding of the present system and method for providing a multi-purpose tool for scale model vehicles. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

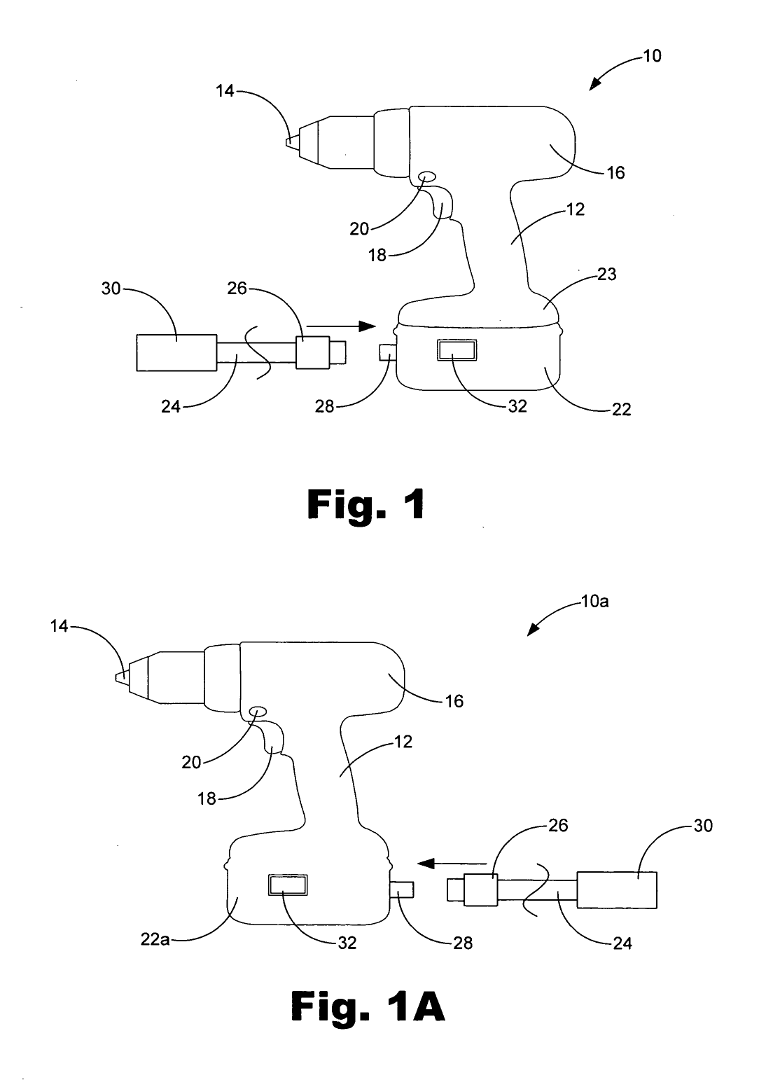

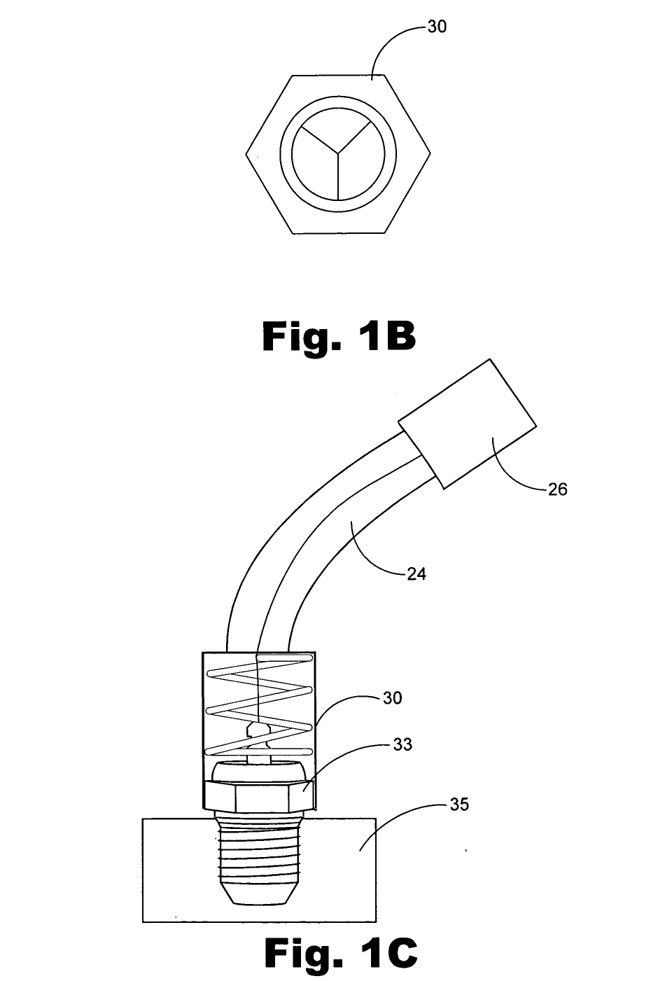

Referring now to FIG. 1, an exploded side view of a multi-purpose tool is shown, indicated generally at (10), in accordance with the principles of the present disclosure. According to one exemplary embodiment, the tool (10) may be a portable electric device having a handle portion (12) configured to be grasped by a user. The tool (10) may have a rotating drive and chuck (14) configured to receive various implements. For example, drill bits, screw drivers, and/or sockets of various sizes and configurations may be attached to the drive (14) for performing various tasks including, but in no way limited to, drilling holes, tightening or loosening screws or bolts, and/or tightening or loosening nuts. It will be understood that the above referenced tasks may commonly be associated with remote controlled model vehicles. However, the present exemplary tool (10) may also be used in various other situations within the scope of the present disclosure. According to one exemplary embodiment, the chuck (14) may be configured to receive and securely connect to the various implements using any number of configurations including, but in no way limited to, the utilization of a key to lock the implements to the tool (10) or a keyless or “quick-connect” chuck, as is known in the art.

As illustrated in FIG. 1, the tool (10) may include a housing (16) configured to enclose a means for imparting a rotational movement to the drive (14). It will be understood that the housing (16) may assume any number of sizes and shapes within the scope of the present disclosure. Moreover, the above-mentioned means for imparting a rotational movement to the drive (14) may be configured in any manner know to those skilled in the art. According to one exemplary embodiment, the means for imparting a rotational movement to the drive (14) may include, but is in no way limited to, a controllable rotational motor including a planetary gear-set configured to be operated at a single speed, multiple speeds, and/or variable speeds.

According to one exemplary embodiment, the means for imparting a rotational movement to the drive (14) may be controlled by an on-off switch (18). As illustrated in FIG. 1, the on-off switch (18) may be configured to be depressed to start rotation of the drive (14), and the on-off switch (18) may be biased such that if the on-off switch (18) is released, rotation of the drive (14) may be stopped. Further, the on-off switch (18) may have variable speed capabilities that vary the rotational velocity of the means for imparting a rotational movement to the drive (14) in response to a position of the on-off switch. The tool (10) may also have a forward-reverse switch (20) for controlling a rotational direction of the drive (14). It will be appreciated that the on-off switch (18) and the forward-reverse switch (20) may be positioned in various different locations on the tool (10). Further, it will be appreciated that the on-off switch (18) and the forward-reverse switch (20) of the preset exemplary tool (10) may be formed in various different configurations as is known in the art.

Additionally, the tool (10) illustrated in FIG. 1 may include a power module or battery pack (22) configured to provide power to the tool (10). As shown in FIG. 1, the battery pack (22) may be detachable, or as shown in the alternative embodiment tool (10a) in FIG. 1A, the battery pack (22a) may be non-detachable. The detachable battery pack (22) illustrated in FIG. 1 may be attached to a body (23) of the tool (10) in any manner known in the art including, but in no way limited to, a latch, snap fit, or a threaded engagement. The battery pack (22) may contain one or more batteries in any number of configurations to supply various desired voltages, as discussed in greater detail below. For example, according to one exemplary embodiment, the batteries may be rechargeable and may supply 7.2 volts or more. One exemplary embodiment of the tool (10) may also include a receptacle (not shown) for recharging the battery pack (22), if desired.

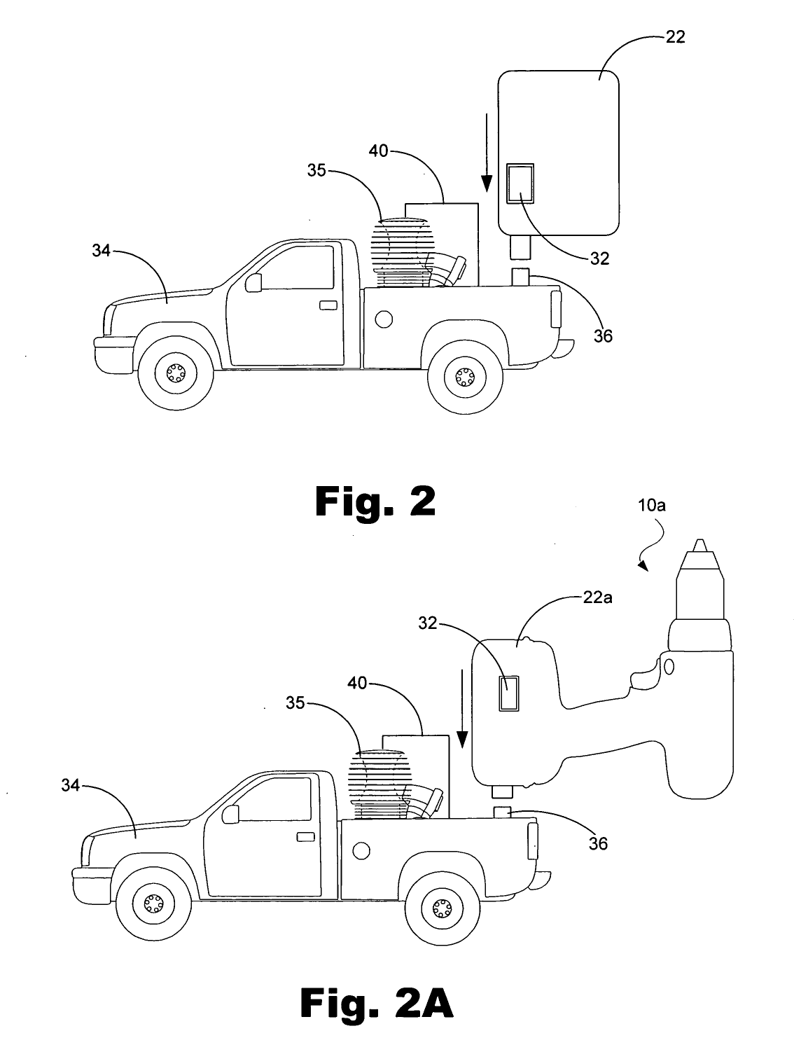

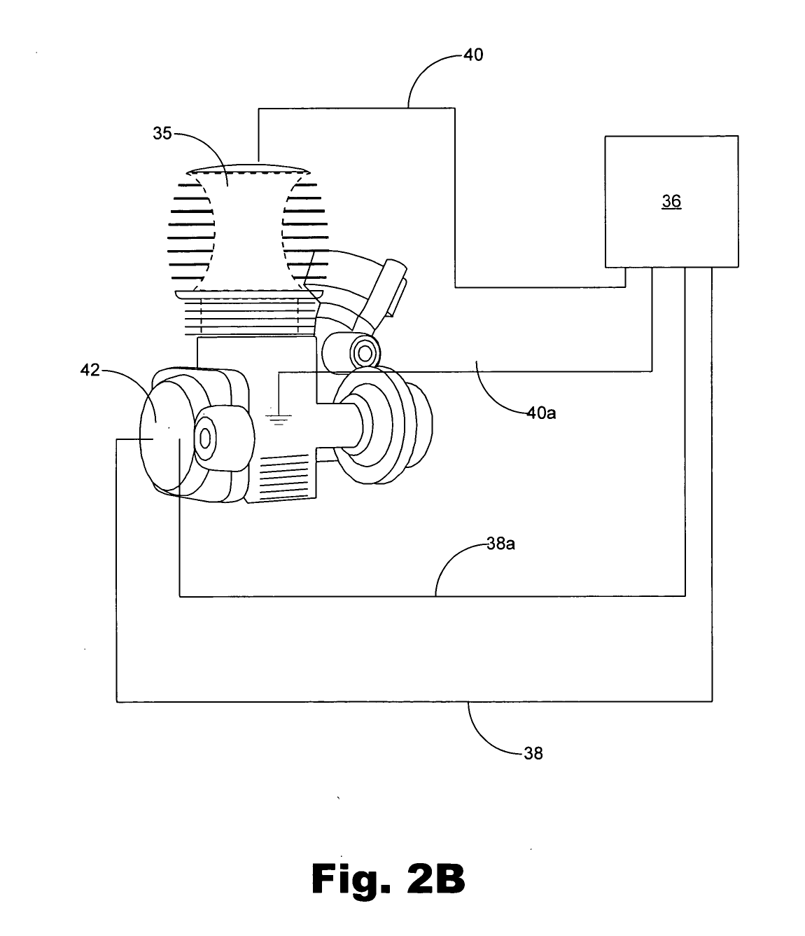

Continuing with FIG. 1, the tool (10) may also include a power cord (24) for supplying power to warm a glow plug of a remote controlled model vehicle, as discussed more fully below. According to one exemplary embodiment, the power cord (24) may have a plug (26) for attaching to the tool (10) at a connector (28). For example, according to one exemplary embodiment, the plug (26) may include a four pin plug, or other attachment mechanism known in the art to electrically connect a cord to a power source, disposed on a first end thereof. Alternatively, the cord (24) may be hardwired to the battery pack (22) and retractably housed therein, according to one exemplary embodiment. Similarly, the connector (28) may be configured as a four pin power plug receptacle compatible with the plug (26) in a manner known in the art. The cord (24) may include a two wire lead, for example, and may also include a glow plug connector (30) on a second end of the cord (24), opposite the plug (26). It will be understood that although the connector (28) may include four pins, when the cord (24) is attached, electrical connection with only two of the pins may be desired as discussed below to allow warming of a glow plug. When a two pin configuration is implemented to warm a glow plug, the other two pins may be used for alternative operations, such as to operate an electrical starter. The glow plug connector (30) may have various different configurations within the scope of the present disclosure adapted to be compatible with glow plug (33) for nitro-methane engines (35; FIG. 2B) commonly utilized in remote controlled model vehicles, as shown in FIG. 1C. For example, one exemplary embodiment of the glow plug connector (30) may include a compression fitting configured as shown in the end view in FIG. 1B.

According to one exemplary embodiment, power may be controllably provided to the cord (24) upon completion of a circuit when the cord (24) is correctly coupled to a glow plug. In contrast, power to initiate an electrical starter may be controlled by a power on-off switch (32) associated with the battery pack (22). It will be understood that while the power on-off switch (32) is illustrated in FIG. 1 as being disposed on the battery pack (22), the power on-off switch (32) may be positioned in any number of locations on the tool (10), and may be formed in various different configurations as is known in the art, such as, but in no way limited to, push button switches.

Referring now to FIG. 2, operation of the tool (10) with a remote controlled model vehicle (34) having an electrical starter motor is shown according to one exemplary embodiment. As shown in FIG. 2, the battery pack (22) may be detached from the body (23; FIG. 1) of the tool (10) for use in starting the vehicle (34). It will be understood, however, that the battery pack (22) may also remain attached to the body (23; FIG. 1) of the tool (10) for use in starting the vehicle (34). According to one exemplary embodiment, the vehicle (34) may include a receptacle plug (36) configured to couple an electrical starter and/or glow plug to a power source such as the present exemplary battery pack (22). According to this exemplary embodiment, the power source provides power via the receptacle plug (36) to operate the electrical starter and/or heat a glow plug. In one exemplary embodiment shown in the schematic wiring diagram in FIG. 2B, the receptacle plug (36) may have two pins and wires (38, 38a) configured to receive electricity, such as 7.2 volts, and two pins and wires (40, 40a) configured to receive a separate voltage, such as 1.2 to 1.5 volts, for example. It will be understood that other voltages may alternatively be used within the scope of the present disclosure. According to the present exemplary embodiment, the 7.2 voltage wires (38, 38a) may be coupled to an electrical starter (42) associated with the vehicle (34; FIG. 2), and the 1.2 to 1.5 voltage wires (40, 40a) may be coupled to a glow plug (35). Once properly coupled, the power on-off switch (32; FIG. 2) may be actuated to provide power to start the electrical starter (42). When the glow plug is heated and the electrical starter starts the engine (35), the engine (35) may continue running under its own power and the battery pack (22; FIG. 2) may be removed from the receptacle plug (36) on the vehicle (34, FIG. 2).

As illustrated in FIG. 2A, the alternative embodiment tool (10a) may be used with the vehicle (34) in a similar manner as described above and as shown in FIG. 2A. More specifically, the alternative embodiment tool (10a) having the battery pack (22a) securely coupled to the body (23) of the tool (10a), may be oriented so as to couple the battery pack to a receptacle plug (36) disposed on the vehicle.

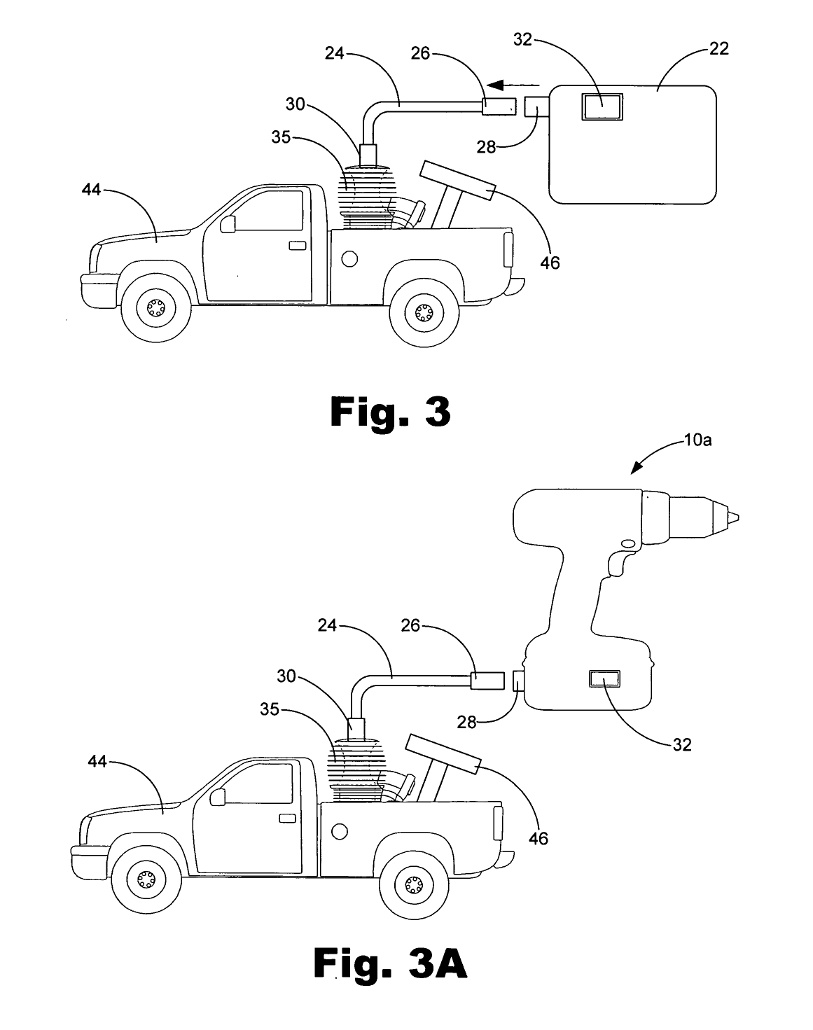

Referring now to FIG. 3, operation of the tool (10) in another scenario, with a remote controlled model vehicle (44) having a manual pull start (46) is shown. According to the exemplary embodiment illustrated in FIG. 3, the glow plug connector (30) of the cord (24) may be coupled to the engine (35), and the plug (26) may be electrically coupled to the connector (28) on the battery pack (22). As discussed above, the battery pack (22) may be attached to the body (23; FIG. 1) of the tool (10), or the battery pack (22) may be detached from the body (23; FIG. 1) of the tool (10). When the glow plug connector (30) is coupled to the glow plug (not shown) disposed on the engine (35), an electrical circuit is completed and electricity is permitted to travel from the battery pack (22) to the glow plug. As the electricity passes to the glow plug disposed on the engine (35), the glow plug is heated and the manual pull start (46) may be operated to start the engine (35). According to one exemplary embodiment, the manual pull start (46) may include a handle and a coiled cord such that the handle may be pulled to impart a rotational force to the engine (35). It will be understood, however, that various different manual pull start devices may be used in connection with the exemplary vehicle (44). Once the engine (35) is started, the glow plug connector (30) of the cord (24) may be removed from the engine (35), allowing for unrestricted operation thereof. It will be understood, according to the exemplary embodiment illustrated in FIG. 3, that the battery pack (22) may provide electricity for heating the glow plug(s) while power to start the engine (35) may be provided manually by the pull start (46). Additionally, as illustrated in FIG. 3A, the alternative embodiment tool (10a) having the battery pack (22) molded to the body (23) of the tool (10a) may be oriented so as to be used with the vehicle (44) in a similar manner as described above and as shown in FIG. 3A.

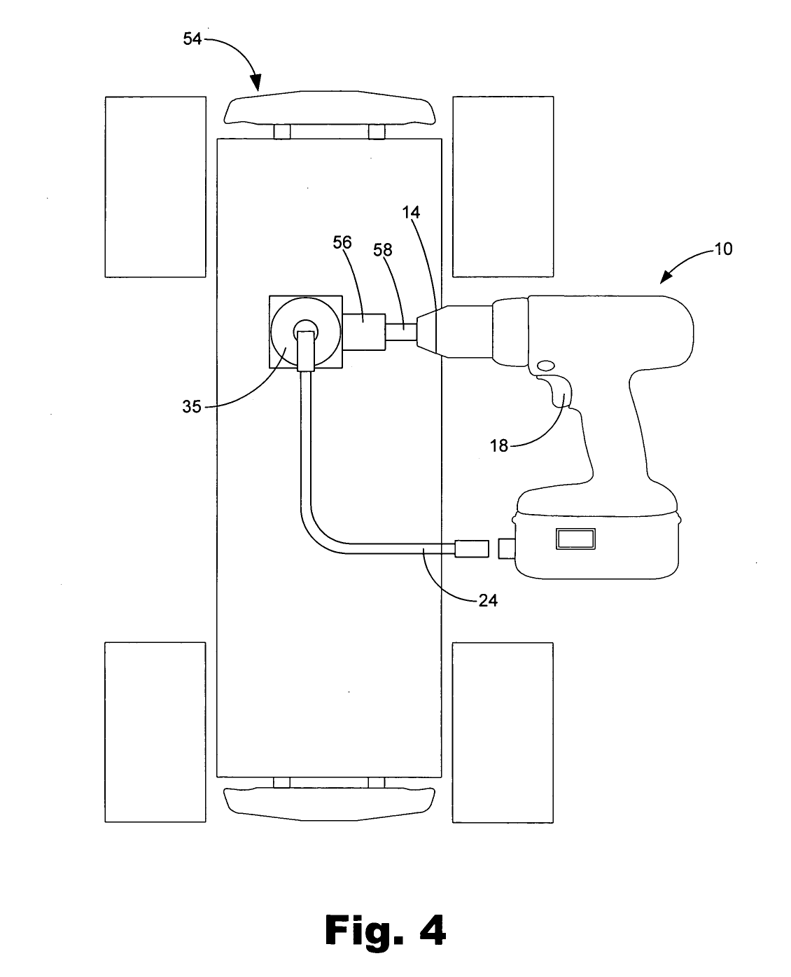

Referring now to FIG. 4, the present exemplary tool (10) may also be used with a remote controlled model vehicle (54) having a mechanical rotary drive start (56), as shown. It will be understood that for ease of illustration, the exemplary remote controlled model vehicle (54) shown in FIG. 4 is viewed from the top with the body of the vehicle (54) removed. As shown in FIG. 4, the cord (24) may be attached to the engine (35) similar to the depiction in FIG. 3 to warm the glow plug. However, in contrast to the exemplary embodiment illustrated in FIG. 3, the rotary drive start (56) may be activated to start the engine (35). According to the exemplary embodiment illustrated in FIG. 4, an implement (58) such as a socket may be attached to the drive (14) of the tool (10) to access and controllably manipulate the mechanical rotary drive start (56). It will be understood that any variety of implements (58) compatible with the mechanical rotary drive start (56) may be attached to the tool (10) for starting the engine (35). The implement (58) may be mated with the mechanical rotary drive start (56) and the on-off switch (18) may then be activated to rotate the mechanical rotary drive start (56), thereby starting the engine (35). Once the engine (35) has started, the tool cord (24) and implement (58) may be selectively removed from the vehicle (54). It will be understood that the alternative embodiment tool (10a) may also be used in a similar manner to start the vehicle (54).

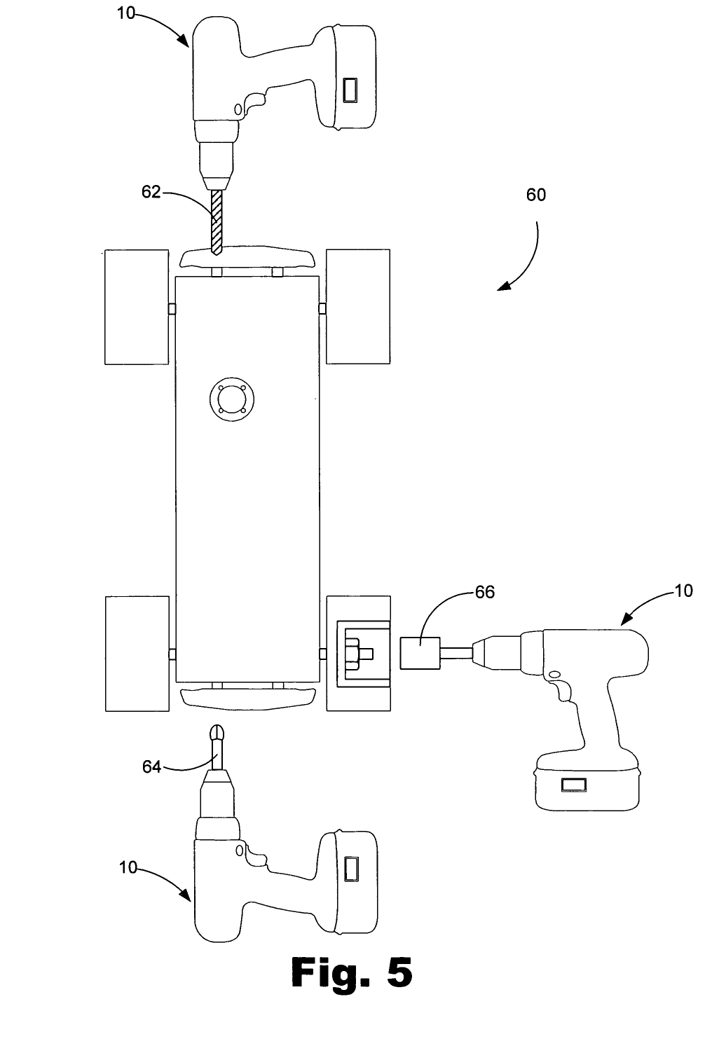

Referring now to FIG. 5, a number of exemplary operations that may be performed by the present multi-purpose tool (10) are shown. For example, as mentioned previously, assembly, operation, and maintenance of a vehicle (60) may entail different tools, such as, but in no way limited to, drills (62), screw drivers (64), and/or sockets (66). As illustrated in the exemplary embodiment of FIG. 5, a drill (62) may be attached to the tool (10) for drilling holes in a vehicle. Similarly, a screw driver (64) may be coupled to the tool (10) for removing or installing screws or bolts. Further, a socket may be coupled to the tool (10) for removing or installing nuts, such as for removing wheels. It will be understood that the cord (24; FIG. 4) may be removed for the performance of the above-mentioned operations. Additionally, the alternative embodiment tool (10a) may also be coupled to the above-mentioned tools to perform the desired operations. Further, the exemplary multi-purpose tool (10) may be used to perform the above-mentioned functions in scenarios unrelated to the field of remote controlled model vehicles.

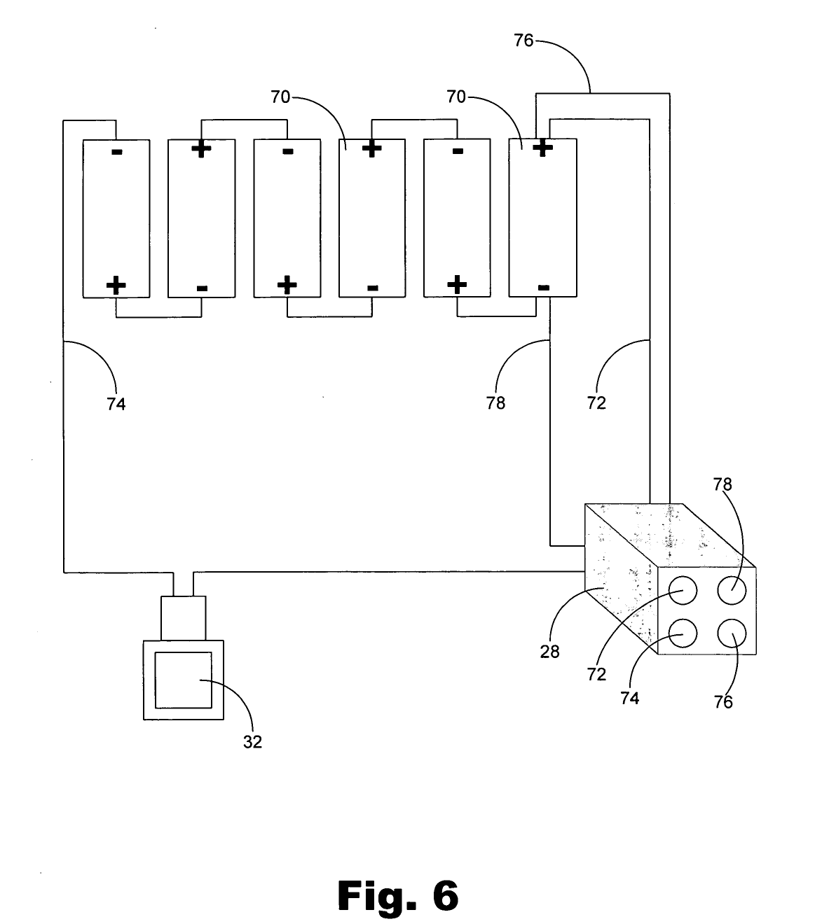

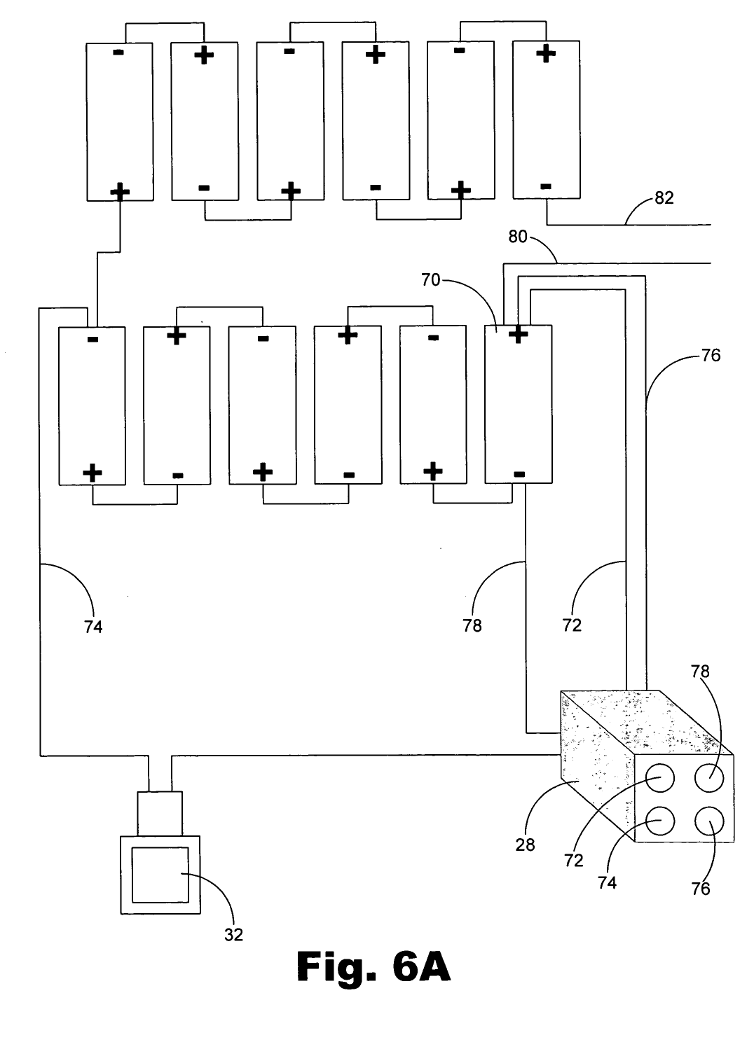

Referring now to FIG. 6, a schematic wiring diagram of the multi-purpose tool (10) is shown. According to one exemplary embodiment, the multi-purpose tool (10) may include one or more batteries (70) or other power supplies. For example, according to one exemplary embodiment, the batteries (70) forming the battery pack (22; FIG. 2) may be approximately 1.2-1.5 volts each. However, it will be appreciated that batteries of any number of different voltages may be used to provide power to the exemplary battery pack (22; FIG. 2). Further, the exemplary batteries (70) may be of any variety known in the art and may be rechargeable. As shown in the exemplary embodiment of FIG. 6, the batteries (70) may be arranged to provide two different voltages to the connector (28; FIG. 1). According to the present exemplary embodiment, a first voltage may be configured for driving an electric starter motor and a second voltage may be configured to heat a glow plug. For example, as illustrated in FIG. 6, a first electric path (72) may be formed from the batteries (70) to the connector (28). As shown, the batteries (70) may be arranged in series, and a second electrical path (74) may be formed at an end of the series of batteries (70) such that the voltage supplied is summed for each of the batteries. For example, if six batteries having 1.2 volts are arranged in series, the voltage of each of the batteries may be added to achieve approximately 7.2 volts at the second electrical path (74). Additionally, a power on-off switch (32) may be placed in the second electrical path (74) to control the flow of electricity to the connector (28). It will be appreciated that the electricity formed by the first electrical path (72) and second electrical path (74) may be used to operate an electrical starter motor.

Continuing with FIG. 6, a third electrical path (76) and a fourth electrical path (78) may be arranged from the batteries (70) to the connector (28). According to the present exemplary embodiment, the third electrical path (76) and fourth electrical path (78) may be arranged such that the voltage of a battery (70), 1.2 volts according to one exemplary embodiment, may be transmitted to the connector (28). It will be understood that when the connector (28; FIG. 1) is attached to the plug (26; FIG. 1) on the cord (24; FIG. 1), and the glow plug connector (30; FIG. 1) of the cord (24, FIG. 1) is attached to a glow plug, a circuit is complete allowing a voltage, such as 1.2 volts, to be supplied to the glow plug from the batteries (70). It will also be appreciated that the third electrical path (76) and the fourth electrical path (78) may be attached to any of the batteries (70).

As shown in FIG. 6A, any number of batteries (70) may be used to achieve a desired voltage. According to the exemplary embodiment illustrated in FIG. 6A, twelve batteries (70) may be used to achieve a desired voltage. As illustrated in the embodiment of FIG. 6A, a fifth electrical path (80) and a sixth electrical path (82) between the batteries (70) may be established. According to the exemplary embodiment illustrated in FIG. 6A, if the batteries are 1.2 volts and there are twelve batteries (70), a voltage of approximately 14.4 volts may be achieved to operate a rotary motor drive. It will be appreciated that voltages common in the remote controlled model vehicle field may range between approximately 7.2 volts and 24 volts, but any voltage known in the art may be utilized within the scope of the present disclosure.

According to yet another exemplary embodiment, a battery pack (22) including all of the capabilities illustrated above is configured to be coupled to any commercially available drill. More specifically, according to one exemplary embodiment, a battery pack (22) is formed to include a connector (28) configured to be attached to a glow plug connector (30; FIG. 3), or to be coupled to and to provide electricity to an electrical starter motor. Additionally, according to this exemplary embodiment, the battery pack (22) may include a power on-off switch (32) to control the flow of electricity to the connector (28). Accordingly, the exemplary battery pack (22) may include a an electrical coupler, including, but in no way limited to a protrusion having leads thereon, configured to provide power to any number of commercially available drills while adding the above-mentioned model vehicle capabilities.

In conclusion, the above-mentioned exemplary multi-purpose tool simultaneously incorporates a number of tool capabilities in to a single tool. More specifically, the above-mentioned multi-tool is configured to provide a power module for providing power to the multi-purpose tool, electrical starters, and glow plugs; and to provide a rotational force drive mechanism for imparting a desired rotational force to a mechanical rotary drive start, a fastener head, a bolt, and/or a drill bit. By incorporating the above-mentioned capabilities into a single tool, model vehicle enthusiasts may perform desired operations with a single tool, thereby reducing the cost of their tool collection and reducing the number of tools to maintain and monitor.

The preceding description has been presented only to illustrate and describe embodiments of the invention. It is not intended to be exhaustive or to limit the invention to any precise form disclosed. Many modifications and variations are possible in light of the above teaching. It is intended that the scope of the system and method be defined by the following claims.

1. A multi-purpose tool comprising:
a power module configured to supply power to said multi-purpose tool;
a drive member coupled to said power module, said drive member being configured to impart a rotational force;
a glow plug heating cord attachable to said power module; and
a connector electrically coupled to said power module, wherein said connector is configured to be electrically coupled to an external electrical device, to supply power from said power module to said external electrical device.

2. The multi-purpose tool of claim 1, wherein said power module comprises one or more voltaic cells.

3. The multi-purpose tool of claim 1, wherein said power module is removably coupled to said drive member.

4. The multi-purpose tool of claim 1, wherein said drive member comprises a mechanical drill.

5. The multi-purpose tool of claim 1, wherein said connector is externally accessible.

6. The multi-purpose tool of claim 1, wherein said glow plug heating cord is configured to be removably coupled to a glow plug of a scale model vehicle.

7. The multi-purpose tool of claim 1, wherein said external electrical device comprises an electrical starter motor.

8. The multi-purpose tool of claim 1, wherein said drive member further comprises a chuck;
said chuck being configured to securely couple a plurality of implements.

9. The multi-purpose tool of claim 8, wherein said plurality of implements comprises at least one of a screw driver, a drill, or a socket.

10. The multi-purpose tool of claim 8, wherein said drive member is further configured to supply rotational energy to a mechanical rotary drive start.

11. A multi-purpose scale model vehicle tool comprising:
a power module configured to supply power to said multi-purpose tool, said power module including an externally accessible connector configured to provide a plurality of voltages generated from said power module;
a rotational drive member electrically coupled to said power module, said rotational drive member being configured to provide a rotational force to start a mechanical rotary drive start on a scale model vehicle; and
a glow plug heating cord attachable to said power module, wherein said glow plug heating cord is configured to simultaneously be electrically coupled to said externally accessible connector and to a glow plug of said scale model vehicle.

12. The multi-purpose scale model vehicle tool of claim 11, wherein said plurality of voltages generated from said power module comprise approximately 1.2 volts and approximately 14.4 volts.

13. The multi-purpose scale model vehicle tool of claim 12, wherein said externally accessible connector is configured to route said 1.2 volts to said glow plug heating cord and said 14.4 volts to an electrical starter motor.

14. The multi-purpose scale model vehicle tool of claim 11, wherein said rotational drive member further comprises a chuck;
said chuck being configured to securely couple a plurality of implements.

15. The multi-purpose scale model vehicle tool of claim 14, wherein said plurality of implements comprises at least one of a screw driver, a drill, or a socket.

16. The multi-purpose scale model vehicle tool of claim 14, wherein said drive member is further configured to supply rotational energy to a mechanical rotary drive start.

17. A multi-purpose tool comprising:
means for warming a glow plug;
means for imparting a rotational force; and
means for supplying electrical power to drive an electrical motor.

18. The multi-purpose tool of claim 17, wherein said means for warming a glow plug is configured to be coupled to and to receive power from said means for supplying electrical power to drive an electrical motor.

19. The multi-purpose tool of claim 17, wherein said means for supplying electrical power to drive an electric motor comprises:
a means for generating power; and
an electrical connector;
wherein said electrical connector is configured to provide a plurality of voltages generated from said means for generating power.

20. The multi-purpose tool of claim 19, wherein said electrical connector is configured to provide an first and a second voltage;
said first voltage corresponding to starting an electric starter motor; and
said second voltage corresponding to heating an electric glow plug.

21. A power module comprising:
a housing;
a plurality of power storage devices disposed within said housing;
a connector electrically coupled to said plurality of power storage devices, wherein said connector is configured to electrically couple said power module to both a glow plug heating cord and an electrical starter motor; and
an electrical coupler configured to electrically couple said plurality of power storage devices to a drill.

22. The power module of claim 21, further comprising a toggle switch disposed on said housing, wherein said toggle switch is configured to selectively control a flow of electricity from said power module to said connector.
